(19) United States
(12) Patent Application Publication
(10) Pub. No.: US 2007/0291112 A1
(43) Pub. Date: Dec. 20, 2007

(54) REMOTE CONTROL HAVING MAGNETIC SENSORS FOR DETERMINING MOTIONS OF THE REMOTE CONTROL IN THREE DIMENSIONS THAT CORRESPOND TO ASSOCIATED SIGNALS THAT CAN BE TRANSMITTED FROM THE REMOTE CONTROL

(76) Inventor: Joseph Harris, West Jordan, UT (US)

Correspondence Address: MORRISS OBRYANT COMPAGNI, P.C., 734 EAST 200 SOUTH, SALT LAKE CITY, UT, 84102, US

(21) Appl. No.: 11/735,242

(22) Filed: Apr. 13, 2007

Related U.S. Application Data
(60) Provisional application No. 60/744,817, filed on Apr. 13, 2006.

(51) Int. Cl. H04N 7/00

(52) U.S. Cl. 348/114

(57) ABSTRACT

A remote control device includes a plurality of magnetic sensors that enable the remote control to determine its orientation in three dimensions, and to determine a change in orientation over time, wherein a user can move the remote control in a first motion relative to a first access to thereby cause a function of the remote control to be actuated, and wherein a user can move the remote control in a second motion relative to a second axis to thereby enable a second function to be actuated, and wherein a user can move the remote control in a third motion relative to a third axis to thereby enable a third function to be actuated.

### CROSS REFERENCE TO RELATED APPLICATIONS

This document claims priority to and incorporates by reference all of the subject matter included in the provisional patent application docket number 3587.CIRQ.PR, having Ser. No. 60/744,817 and filed on Apr. 13, 2006.

### BACKGROUND OF THE INVENTION

1. Field of the Invention

This invention relates generally to the remote control of electronic devices that receive input from a remote control device. More specifically, the invention is a system and method for detecting the rotational and translational motions of a remote control in three dimensional space, finding an a command signal that is associated with the detected motions, and then transmitting the command signal, thereby enabling motions of the remote control to generate command signals.

2. Description of Related Art

Remote controls are already indispensable in a typical family or media control room. Televisions, cable tuners, satellite receivers, DVD recorders and players, digital video recorders, VCRs, stereos, and receivers are just some of the many electronic devices that can be controlled by a remote control device.

Remote controls themselves vary in the complexity and number of devices that they can control. Some have display screens, while others do not. Some can control a single electronic device, while others can control many devices.

One particular problem with remote controls is that the number of buttons is typically increasing. The increase in buttons can generally be attributed to the growing variety of electronic devices that a single remote is often required control. The variety of electronic devices often have functions that are not duplicated by any other device, so the controls must be included.

Accordingly, it would be an advantage over the state of the art of remote control devices to have fewer buttons, but no decrease in functionality. It would be another advantage to simply operation of the variety of electronic devices by enabling simple and repeatable movements of the remote control to function as the means of entering commands.

Another problem with remote controls is that the large number of buttons can make it difficult to locate the particular button that is needed, especially when the user is not looking at the remote, or the remote is being used in dim lighting conditions.

Accordingly, it would be another advantage over the state of the art of remote control devices to enable a user to control certain functions of a remote control without having to be able to see the buttons when certain functions of the remote control are being used.

### BRIEF SUMMARY OF THE INVENTION

In one embodiment of the present invention, a remote control device includes a plurality of magnetic sensors that enable the remote control to determine what rotational and translational motions are being performed by the remote control, wherein a user moves the remote control in a specific rotational motion, translational motion or combination of rotational and/or translational motions, wherein a motion or motions are associated with specific command signals that are transmitted by the remote control for the remote operation of electronic devices.

In a first aspect of the invention, one motion of the remote control is to rotate the remote control back and forth relative to a long axis.

In a second aspect of the invention, another motion of the remote control is to pitch the remote control backwards and forwards relative to a second axis that is perpendicular to the long axis.

In a third aspect of the invention, another motion of the remote control is to rotate the remote control from side to side relative to a third axis that is perpendicular to the long axis and the second axis.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a top elevational view of magnetic field sensors set out in three specific locations to enable detection of orientation of the sensors in three dimensions.

FIG. 2 is a circuit diagram of the magnetic sensors used in the present invention.

FIG. 3 is a perspective view of motion of the remote control relative to a first axis.

FIG. 4 is a front view of the remote control of FIG. 3.

FIG. 5 is a perspective view of motion of the remote control relative to a second axis.

FIG. 6 is a perspective view of motion of the remote control relative to a third axis.

FIG. 7 is a perspective view describing the translational motions that can be performed with the remote control.

FIG. 8 is a block diagram showing components of the remote control in a typical embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

A first embodiment of the present invention is a plurality of magnetic sensors that are capable of determining the orientation of a remote control wherein the magnetic sensors are disposed. The plurality of magnetic sensors are directionally sensitive devices. For example, the magnetic sensors can be a magnetic field sensor such as one having part number KMZ51 from Philips Semiconductors. However, any similarly functioning magnetic sensor can be substituted to thereby generate the same or similar results. It is noted that the magnetic field sensor KMZ51 is relatively inexpensive, and is thus desirable for the applications herein. This type of magnetic sensor was designed to sense the earth's magnetic field, and is thus an excellent choice for the present invention.

In this first embodiment, the magnetic field sensors are disposed in sets of three, stacked one on top of the other or arranged side-by-side and separated by a non-conductive material such as PC board when they are stacked. Each set of magnetic field sensors provides a vector. Thus, three pairs of magnetic field sensors are sufficient to provide three vectors, and thus determine the orientation of the remote control in three dimensions. The three pairs of magnetic field sensors are arranged relative to each other so as to sense a magnetic field in axes that are perpendicular to each other.

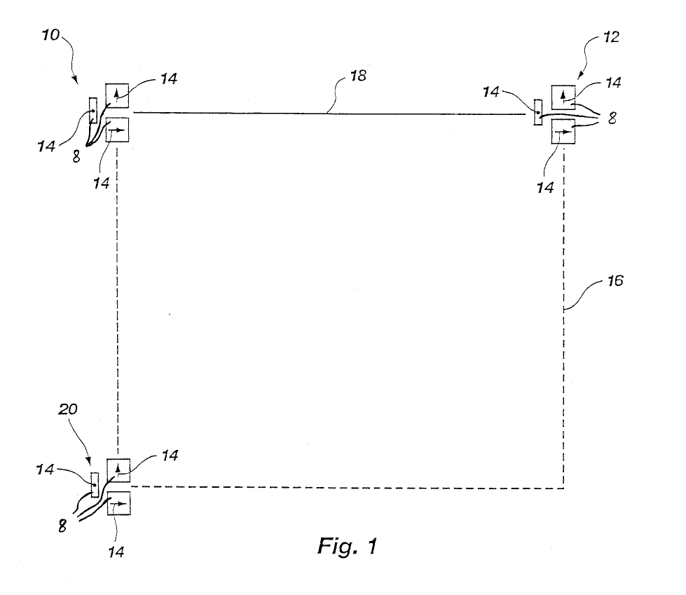

It is noted that in this first embodiment, three magnetic field sensor sets could be arranged so as to have a straight line between them. For example, FIG. 1 shows a first magnetic sensor set 10, and a second magnetic sensor set 12, each set comprised of three magnetic field sensors 8. The directional sensitivity of each of the magnetic field sensors 8 is identified by the arrows 14. Note that the dot representing an arrow 14 in each set 10, 12 indicates that sensitivity is directed out of the page. The approximate area of sensitivity is identified by dotted line 16.

Each magnetic field sensor includes a flip or polarizing coil. The polarizing coil allows a user to re-align or polarize the magnetic field sensor to the direction in which it is sensitive. This feature enables a user to cancel out offsets, drift, etc. Generally, a user will only re-align or polarize in order to occasionally “zero-out” the magnetic field sensor, but will generally not perform this operation before every measurement. The magnetic field sensors generally have good bandwidth, from about 1 volt DC to about 1 MHZ.

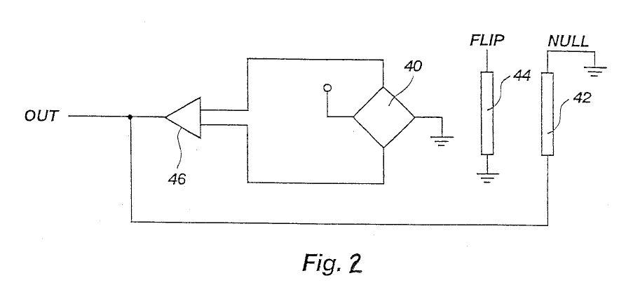

As shown in FIG. 2, the magnetic field sensor is essentially a bridge 40, which also includes a nulling coil 42 and a flipping coil 44. In order to get a good dynamic range, it is best to avoid flipping before each measurement because as the magnetic field grows higher and higher, it starts saturating the magnetic field sensor. At that point, the magnetic field sensor begins to lose linearity.

Accordingly, the preferred magnetic field sensor includes a nulling coil 42. The output of a differential amplifier 46 is fed back into the nulling coil 42. This allows obtaining a “zero” magnetic field on the magnetic field sensor, to thereby increase gain immensely while maintaining linearity.

It is important to realize that if the sensor system is to be accurate, the complete sensor system 20 should not try to maintain a linear circuit. Instead, the user should select a null point, and then feed a linear DAC into it to maintain a null point. That provides the sensor system with a much improved and increased linear range. By using the nulling coil 42, it is possible to maintain linearity and a better dynamic range.

The sets of magnetic sensors are disposed in remote controls and enable the detection of a range of different motions that can be performed with a remote control. Some examples of possible motions of the remote controls are described in the following figures. Generally, these motions are either rotational, translational, or a combination of the two.

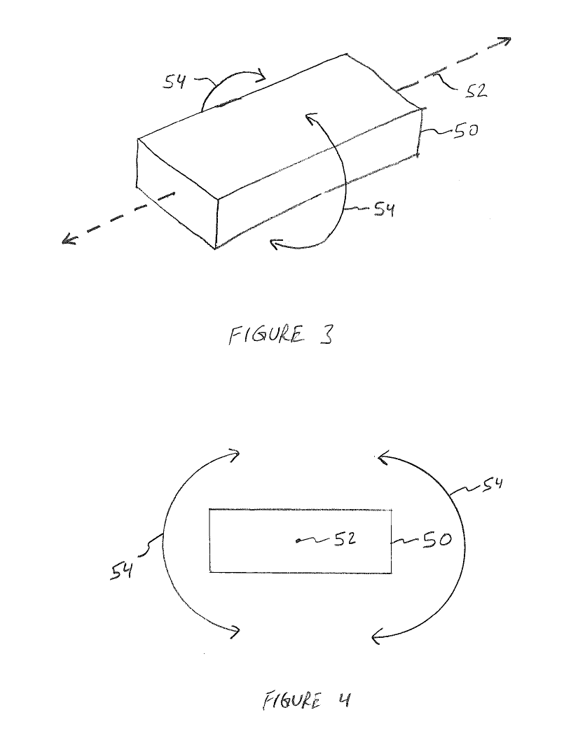

FIG. 3 is a perspective view of a remote control 50 and a long axis 52 thereof. The remote control 50 is rotated as shown in the direction of the arrows 54. The movement is arbitrarily assigned to any desired function, such as incrementing the volume or channels of a television up or down. The user could push a button on the remote control to signal that movements using the first motion would cause action to move to the left. Similarly, a different button on the remote control signals that movements using the first motion would cause action to move to the right. An intuitive manner of implementing this concept would be to place buttons on the right and left side of the remote control 50, but this aspect is not limited to any such design.

FIG. 4 is provided as the front view of the remote control 50 in FIG. 3, again showing the “rocking” rotational motion described by arrows 54.

The function that can be controlled should not be considered to be limited to volume or channel controls. For example, the function could be to move an indicator that highlights certain words on a display screen. Another example of a function would be to navigate through menus or channels. The first motion could thus be assigned to the action of moving the highlight indicator up and down in a menu, or to move left or right in the menu.

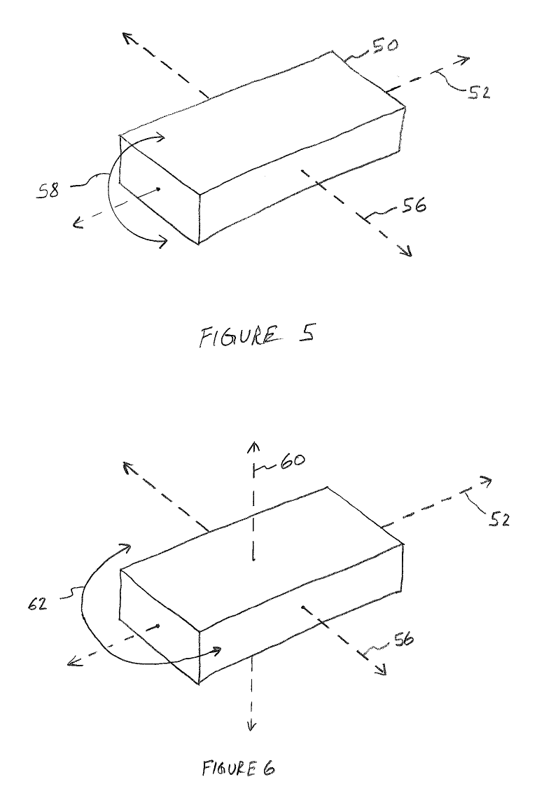

In a second aspect of the invention, another possible motion of the remote control is to rotationally pitch the remote control backwards and forwards. This rotational motion is illustrated in FIG. 5. FIG. 5 shows the remote control 50 and the long axis 52. A second axis 56 is now shown disposed as being perpendicular to the first axis 52. Movement of the remote control 50 would be to pitch it forwards and backwards, rotating the remote control relative to the second axis 52 as indicated by arrows 58. Again, any function can be associated with this second rotational motion.

An example of an intuitive motion that might be associated with the motion shown in FIG. 5 might be to increase or decrease some value by the pitching up or down of the remote control 50. For example, a user might press a VOLUME UP button, and then any significant motion that can be determined to be a “pitching up” motion beyond some detectable and predetermined threshold motion would be determined to be a command to increase the volume by one incremental value. Any other motion of the remote control 50 would be ignored while the “mode” of the remote control 50 has been set to adjust volume. The user is then free to “reset” the remote control 50 by pitching the remote control 50 downwards so that it can be conveniently pitched upwards to again increment the volume control.

It is another aspect of the invention to provide “modes” of operation, wherein the remote control 50 can be moved in any desired manner, but only a specific motion will cause the desired function to occur. The user would then use buttons to change from mode to mode, allowing actual commands for that mode to be determined by motions of the remote control 50.

It may also be convenient to assign a particular motion that has the effect of cancelling the last command given. This “cancel last command” instruction might be made available in all modes of operation. Providing such a command would enable a user to quickly undo or cancel any commands that were inadvertently sent by unintended motions of the remote control 50.

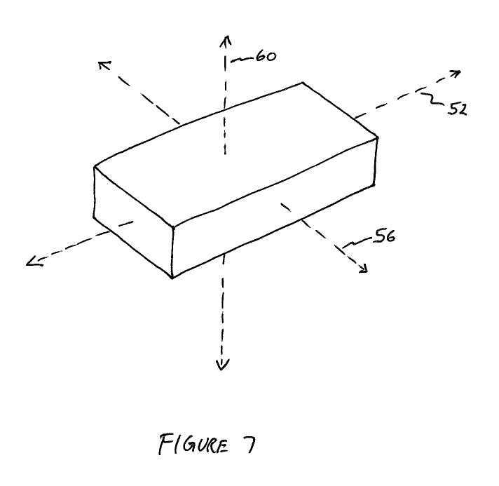

In another aspect of the invention, another possible motion of the remote control 50 is to rotate the remote control from side to side relative to a third axis 60 that is perpendicular to the long axis 52 and the second axis 56. This motion is illustrated in FIG. 6. FIG. 6 shows the motion of the remote control 50 as indicated by arrows 62. Note that all three axes 52, 56, 60 will intersect at a single point in the center of the remote control 50.

It should be observed that the remote control 50 is not an absolute positioning device. In other words, the remote control 50 uses relative positioning to determine how the remote control is initially oriented, and how that orientation changes with respect to time. Without having to perform any initialization of the remote control, circuitry is also simplified.

Another aspect of the invention is the ability to recognize movement in more than a single axis. In other words, while the figures have identified motion relative to a single access, the motion can be in multiple axes. This motion in multiple axes can by simultaneous or discrete, and would include all of the rotational motions shown in FIGS. 3 through 6.

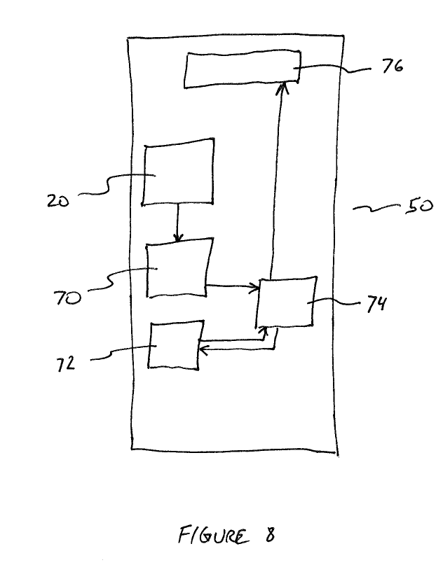

Another aspect of the present invention is translational motion of the remote control. The motions described in FIGS. 3 through 6 have been rotational motions, but translational motions are also possible. For example, as shown in FIG. 7, the remote control 50 can be raised, lowered, pushed forward, pushed backwards, or moved from side to side without actually rotating it as indicated by the arrows 54, 58 and 62 of the previous FIGS. 3, 5 and 6. Thus, translational motion without rotation of the remote control 50 can also be interpreted as a command.

It should also be understood that motion of the remote control is not restricted to straight lines, or even along the axes of the remote control as indicated by the axis arrows 52, 56 and 60 of FIG. 7. The remote control 50 can be put through diagonal and even arcing motions. The range of motions that are possible in three dimensions should all be considered to be within the scope of the present invention, and the capabilities of detection using the sensors described herein. Thus, a user might move the remote control in a “FIG. 8” or any other curved or arced path.

Another aspect of the invention is to combine purely translational motions with purely rotational motions, but only performing the motions exclusively of the other. Thus, one type of motion is performed, followed within a set period of time by the other type of motion. For example, a user might rotate the remote control as show in FIG. 5, and then move it translationally to complete the command. The opposite could also be done, where a translational motion is followed by a rotational motion. It is envisioned that any number of combinations of translational and/or rotational motions might be performed in a sequence to execute commands.

It is noted that the remote control will send signals to the electronic device being controlled via infra-red or radio frequency signals that are already in use by remote controls and known to those skilled in the art. The motion of the remote control caused by the user is simply a method of determining what control signal is to be transmitted to the electronic device.

FIG. 8 shows in a block diagram that the remote control 50 within which the sensor system 20 is disposed must include several components or systems for performing the functions of the remote control. For example, the remote control 50 must include some memory system 70 for holding, at least temporarily, the rotational and translational motions being performed by the remote control. This memory system 70 can be a simple memory buffer or register in stand-alone memory, or be a memory register in a simple processor.

The remote control 50 must also be capable of comparing the recorded motion or motions with a table of commands 72. The table of commands 72 must also be associated with corresponding rotational and/or translational motion or motions. A processor 74 must make a comparison of the motion or motions performed and recorded, and the table of corresponding commands 72 to determine what command signal should be transmitted by the remote control 50. Accordingly, the remote control 50 also includes a transmitter 76.

The table of commands 72 and associated motions can typically be stored in any permanent or modifiable memory of the remote control 50. It may be desirable to be able to reassign motions to particular commands. This would make the remote control 50 more customizable to the user.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A remote control system for transmitting commands that are determined by rotational and translational motions of a remote control, said remote control system comprising:
a sensor system disposed inside a remote control that is capable of determining what rotational and translational motions are performed by the remote control being moved in three dimensions; and
a memory for recording the rotational and translational motions of the remote control;
a processor for correlating the rotational and translational motions of the remote control to associated commands; and
a transmitter for sending the associated command from the remote control.

2. The remote control system as defined in claim 1 wherein the sensor system further comprises a magnetic sensing system for determining what rotational and translational motions are performed by the remote control.

3. A method for using rotational and translational motions of a remote control system to generate a command signal, said method comprising the steps of:
(1) providing a remote control that includes a sensor system for determining what motion is performed by the remote control;
(2) moving the remote control by performing at least one motion;
(3) determining what motion has been performed;
(4) determining what command signal is associated with the motion that has been performed; and
(5) transmitting the command signal.

4. The method as defined in claim 3 wherein the method further comprises the step of enabling the remote control to perform a plurality of motions that can be grouped together as a single command.

5. The method as defined in claim 4 wherein the method further comprises the step of detecting motion from the group of motions comprised of rotational, translational, and combinations thereof.

6. The method as defined in claim 3 wherein the method further comprises the step of providing a magnetic sensor system for determining what motion is performed by the remote control.

7. The method as defined in claim 3 wherein the method further comprises the step of temporarily recording the motion in a memory register for further processing.

8. The method as defined in claim 7 wherein the method further comprises the steps of:
(1) comparing the recorded motion to a list of possible motions to identify which motion has been performed by the remote control; and
(2) locating the command signal that is associated with the identified motion.

9. The method as defined in claim 3 wherein the method further comprises the step of selecting a transmitter for the remote control from the group of transmitters comprised of radio frequency transmitters and infra-red transmitters.
